(19) United States
(12) Patent Application Publication
(10) Pub. No.: US 2024/0354090 A1
(43) Pub. Date: Oct. 24, 2024

(54) Asynchronous Caching for Stateful Applications

(71) Applicant: RED HAT, INC., Raleigh, NC (US)

(72) Inventors: Matteo Mortari, Binasco (IT); Edoardo Vacchi, Milan (IT)

(21) Appl. No.: 18/135,923

(22) Filed: Apr. 18, 2023

(51) Int. Cl. G06F 8/65; G06F 11/20; G06F 12/0815

(52) U.S. Cl. CPC G06F 8/65; G06F 11/2023; G06F 12/0815

(57) ABSTRACT

Automatic caching for stateful applications can be implemented using aspect-oriented programming. In one example, a caching tool can detect, based on a selection from a client device, an update to a property of an instance of a software application. The caching tool can further identify a match between the update to the property and a predefined aspect. In response to the identifying the match, the caching tool may determine stateful information for the instance based on the selection from the client device. In response to determining the stateful information, the caching tool may automatically execute an asynchronous caching function to store, in a cache, the stateful information.

### TECHNICAL FIELD

The present disclosure relates generally to executing computing operations on computing systems and, more particularly (although not necessarily exclusively), to automatically executing an asynchronous caching function to store stateful information for stateful applications.

### BACKGROUND

A distributed computing environment can include networked nodes (e.g., physical or virtual machines) that can coordinate their actions by passing messages to one another. Examples of distributed computing environments can include a cloud computing system, a computing cluster, etc. The distributed computing environments can execute software services for providing services to users. Some software services are designed to be stateful and other software services are designed to be stateless. Stateful services are allocated storage on the server side for storing state information for the duration of a user session. The state information can include information that preserves the state, or context, of the user session. Stateful services may depend on previous user interactions with the application to maintain context for a user of the software service on the server side for the duration of the session.

### BRIEF DESCRIPTION OF THE DRAWINGS

FIG. 1 is a block diagram of an example of a computing environment for automatically executing an asynchronous caching function to store stateful information according to one example of the present disclosure.

FIG. 2 is a block diagram of an example of a computing device for automatically executing an asynchronous caching function to store stateful information according to one example of the present disclosure.

FIG. 3 is a flowchart of an example of a process for automatically executing an asynchronous caching function to store stateful information according to one example of the present disclosure.

FIG. 4 is a flowchart of an example of a process for automatically executing an asynchronous caching function to store stateful information according to one example of the present disclosure.

FIG. 5 is a flowchart of an example of a process for automatically executing an asynchronous caching function to store stateful information according to one example of the present disclosure.

### DETAILED DESCRIPTION

To provide software services (e.g., software applications) that are stateful, stateful information may be stored. The stateful information can be data representative of a session of user interaction with, for example, a software application. The stateful information can then be used at a subsequent session of user interaction with the software application to cause the software application to retain information such as user preferences, user actions, etc. In some instances, a software application that was not designed to be stateful may be modified to become stateful. Therefore, a software developer for the software application may implement a strategy for storing the stateful information. For instance, specific locations in code for the software application can be modified to cause stateful information to be stored in, for example, a cache. In particular, for software applications that use object-oriented programming (OOP), the software developer may manually insert caching commands at each relevant location in the code (e.g., for functions, modules, etc. of the software application). As a result, the caching commands can hinder readability of the code and increase a number of failure points when executing the software application.

Additionally, issues that may arise when executing the caching commands can include degradation of services provided by the software application. For example, an execution failure of any of the manually inserted caching commands can lead to missing or inaccurate stateful information being stored, which can cause the degradation of services. For example, the software application may provide inaccurate data at the subsequent session of user interaction. Moreover, the manual insertion of the commands can be time consuming, and, in some examples, the software developer may not have access to particular sections of the original source code used for the software application. For instance, some code that may be beneficially rendered cache-aware may no longer come with its original source code, or its original source code may be owned by another entity (e.g., a third-party library). Thus, it may be difficult or impossible to modify such sections of code to become cache-aware.

Some examples of the present disclosure can overcome one or more of the above mentioned problems via a caching tool that can automatically execute an asynchronous caching function to store stateful information for a software application in a cache. The caching tool can provide a more efficient method for storing stateful information that does not require manual insertion of caching commands in each relevant portion of code for the software application. The caching tool can automatically execute the asynchronous caching function using aspect-oriented programming (AOP). AOP can enable behaviors (e.g., the execution of the asynchronous caching function) to be added to existing code without modifying the original source code itself. Due to AOP, the asynchronous caching function can be executed in parallel to the software application. Consequently, the execution of the asynchronous caching function can occur separately from the execution of the software application. Therefore, the code can be rendered cache-aware without adding additional behaviors directly to the original source code for the software application, which may significantly reduce latency of the software application. And, issues with the asynchronous caching function may not disrupt the functioning of the software application.

Moreover, the caching tool can automatically execute the caching function based on a predefined aspect. An aspect is a special class that defines a point of execution for a cross-cutting concern for the software application. The cross-cutting concern can be a concern that crosscuts multiple functions, procedures, modules, etc. of the software application, such as storing stateful information, logging, etc. The caching tool can therefore automatically alter behavior of the code for the software application by implementing an additional behavior (e.g., the asynchronous caching function) associated with the cross-cutting concern at the point of execution defined by the predefined aspect. As a result, the caching tool can execute the asynchronous caching function at more locations in the code than if the commands were inserted manually, such as in particular sections of the original source code that may not be accessible to the software developer. Additionally, issues that may arise with the asynchronous caching function, such as an execution failure, can be debugged more efficiently than an issue with the manually inserted commands due to the predefined aspect and asynchronous caching function being separate from and more concise than the manually inserted caching commands. Thus, the caching tool can improve an accuracy of and increase an amount of stateful information stored for the software application, which can improve performance of services provided by the software application. In this way, end-user code can be augmented to transparently inject caching inside user-defined entities, regardless of whether the original source code is explicitly marked as or is implicitly a candidate for caching.

In a particular example, a user may be interacting with a software application via a client device. In particular, the user may select, via the client device, an item to cause the item to be added to a shopping cart of the software application. As a result, the caching tool may detect an update to a property of an instance of the software application based on the selection of the item from client device. For example, the shopping cart can be a type (i.e., a structure with properties) of the software application. The user's shopping cart can be a specific occurrence of the type (i.e., the instance) of the software application. The properties (i.e., specific attributes of the type that can be read or modified) of the shopping cart can be items. Thus, the update to the property of the instance of the software application can be the addition of the item to the user's shopping cart.

The caching tool can then determine whether the update to the property of the instance matches a predefined aspect. For example, the predefined aspect can indicate that updates to the property of “items” for the type of “shopping cart” for the software application should be cached. The predefined aspect may further indicate types of updates that should be cached, such as an addition of an item or a removal of an item from a shopping cart. As a result, the caching tool can determine that the addition of the item to the user's shopping cart does match the predefined aspect.

In response to determining that the update to the property matches the predefined aspect, the caching tool can further determine stateful information for the instance based on the selection of the item from the client device. The stateful information can be data representative of the user adding the item to the shopping cart. For example, the stateful information may include a name of the item, a price of the item, a product code for the item, a time at which the item was added to the shopping cart, or other suitable data. Then, in response to determining the stateful information, the caching tool can automatically execute an asynchronous caching function to store, in a cache, the stateful information. The stateful information can be stored for use at a subsequent interaction with the user to maintain a state of the software application. For example, due to the stateful information being stored, the item can be in the shopping cart at the subsequent interaction between the software application and the user.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

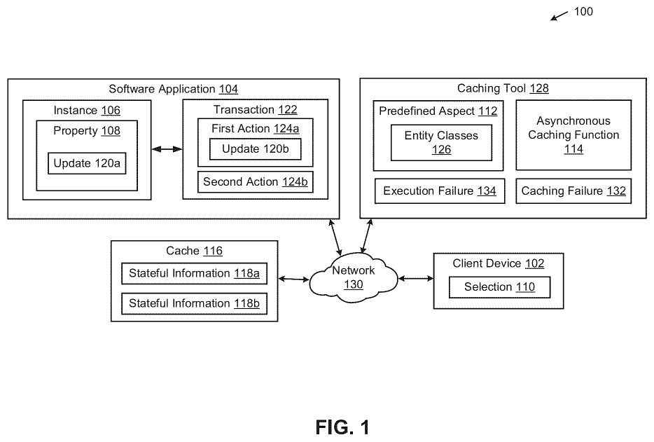

FIG. 1 is a block diagram of an example of a computing environment 100 for automatically executing an asynchronous caching function 114 to store stateful information according to one example of the present disclosure. The computing environment 100 may be a distributed computing environment, such as a cloud computing system, a computing cluster, etc. formed from one or more nodes (e.g., physical or virtual servers) that are in communication with one another via a network 130. Additionally, the computing environment 100 can include a caching tool 128, a software application 104, a cache 116, and a client device 102, which can be communicatively coupled via the network 130. Examples of the network 130 can include a local area network (LAN) or the Internet. The computing environment 100 can further be formed from a physical infrastructure that includes various network hardware, such as routers, hubs, bridges, switches, and firewalls. The physical infrastructure can also include one or more servers. The servers may provide backend support for the software application 104 or another suitable software service (e.g., a microservice).

In some examples, the software application 104 can be a stateful application. Examples of stateful applications can include E-commerce associated applications that store data associated with customer orders, shipping information, etc., social media platforms that store data associated with user profiles, user preferences, etc., cloud computing platforms that store information about virtual machines, network configurations, etc., or other any other suitable applications for which stateful information (i.e., data associated with user interaction) can be stored and used at subsequent user interactions. The caching tool 128 may be a sidecar (e.g., in a Kubernetes cluster) or entirely remote from the software application 104. In some examples, the caching tool 128 can be compatible with DataSource and Memory based systems such as Rule Engine (e.g., Drools). The caching tool 128 can monitor the software application 104 and facilitate storage of the stateful information.

For example, the caching tool 128 can detect a first update 120a to a property 108 of an instance 106 of the software application 104. The software application 104 can include code written in an object-oriented programming (OOP) language. The code for the software application 104 can include types (i.e., structures with properties), instances (i.e., specific occurrences of the types that have values for the properties), properties (i.e., attributes of a type structure which can be modified or read), and transactions (i.e., sets of actions for performing specific tasks). A user can interact with the software application 104, and as a result, updates may be made to properties of instances or transactions may become active. Therefore, the detection of the first update 120a can be based on a selection 110 from the client device 102. The selection 110 can be a result of a user interaction with the software application 104 performed via the client device 102. In a particular example, the user of the client device 102 may be performing an authentication process for the software application 104. Therefore, the selection 110 from the client device 102 can be a submission of authentication credentials.

Additionally, in the particular example, a type for the software application 104 can be users and properties for the type can include a first property of a username, a second property of a password, and a third property of an indication whether access to the software application is allowed. In this instance 106, the user can input values for the properties. For example, the values for the properties can include a first value of a username for the user and a second value of a password for the user. Additionally, the first update 120a can be an update to a third value for the third property. For example, the software application 104 may update the third value from “not allowed” to “allowed” based on the selection 110 (e.g., if the username and password are valid authorization credentials). Thus, the property 108 can correspond to the third property of the instance 106.

As the software application 104 is executing, the caching tool 128 can identify a match between the first update 120a to the property 108 and a predefined aspect 112. The predefined aspect 112 can be a special class that defines a point of execution for a cross-cutting concern for the software application. The cross-cutting concern can be the storage stateful information, which cross-cuts modules, functions, etc. of the software application 104 in which the types, instances, etc. of the software application 104 can be found. The predefined aspect 112 can be written using aspect-oriented programming (AOP). AOP can complement OOP by enabling behaviors (e.g., the execution of the asynchronous caching function 114) to be added to the code for the software application 104 without modifying the original source code itself. Therefore, the predefined aspect 112 can define a point of execution for the asynchronous caching function 114. The caching tool 128 can determine that the first update 120a to the property 108 matches the definition of the point of execution. In the particular example, the predefined aspect 112 may indicate that property updates for the type (i.e., users) to “allowed” should be cached. Therefore, in the particular example, the caching tool 128 can determine that the first update 120a to the property 108 matches the predefined aspect 112.

Additionally or alternatively, the caching tool 128 can determine that the first update 120a to the property 108 matches an entity class. For example, the entity class can define a type (e.g., users) or one or more instances of the type that should be cached. In this way, the predefined aspect 112 can be more broadly defined to cause, for example, any update to any property of any instance of the type to be cached. In some examples, the entity class can further be defined to exclude caching of certain updates, certain properties, certain instances, etc. to manage storage space.

If the first update 120a to the property 108 matches the predefined aspect 112, the caching tool 128 can further determine first stateful information 118a for the instance 106. The first stateful information 118a can be based on the selection 110 from the client device 102. For example, the first stateful information 118a can include a timestamp for the selection 110, the values for the properties of the instance 106, the authentication credentials, or other suitable data associated with the selection 110. The first stateful information 118a can be useful for a subsequent user interaction with the software application 104. For example, the authentication credentials can be stored to expedite a subsequent authentication process performed by the user via the client device 102.

Additionally, in response to determining the first stateful information 118a, the caching tool 128 can automatically execute the asynchronous caching function 114 to store the first stateful information 120a in the cache 116. In this way, the asynchronous caching function 114 can be automatically executed in relevant places, such as a location in the code associated with the first update 120a to the property 108, based on the predefined aspect 112 to efficiently store stateful information. Additionally, the cache 116 can be a hardware or software component of the computing environment 100 for storing data (e.g., stateful information). In some examples, the cache 116 may temporarily store the data, such as for a predetermined length of time.

Additionally or alternatively, after the client device 102 transmits the selection 110 from the user, the caching tool 128 may determine that a transaction 122 for the instance 106 of the software application 104 is active. The transaction 122 can be a set of actions for performing a specific task with respect to the software application 104. For example, the transaction 122 can include performing a series of authentication steps to establish the user as an authorized user. Thus, a first action 124a of the transaction 122 may cause a second update 120b to the instance 106 to occur, where the second update 120b can be associated with establishing the user as the authorized user.

In some examples, the caching tool 128 may determine that the transaction 122 is active even if the first update 120a to the property 108 does not match the predefined aspect 112. In this way, updates to properties of instances of the software application 104 not indicated by the predefined aspect 112 or the entity class may be cached.

If the transaction 122 is active, the caching tool 128 may automatically execute the asynchronous caching function 114 to store second stateful information 118b in the cache 116. To do so, the caching tool 128 may determine the second stateful information 118b. The second stateful information 118b can be associated with the transaction 122, the instance 106, the updates 120a-b, etc. In some examples, the caching tool 128 may determine the second stateful information 118b in response to determining that the second update 120b matches the predefined aspect 112 or another suitable predefined aspect. For example, the caching tool 128 may determine the second stateful information 118b based on the second update 120b generated at the first action 124a. Therefore, in the particular example, the second stateful information 118b may include the authentication credentials submitted at the selection 110.

In some examples, the caching tool 128 may further execute a second action 124b of the transaction 122 based at least in part of the second stateful information 118b stored in the cached 116. For example, the second action 124b can include storing the authentication credentials in a list of the software application 104. The list can be a list of authentication credentials for authorized users of software application 104. Therefore, the second stateful information 118b, which includes the authentication credentials used at the selection 110, can be used for the execution of the second action 124b.

In some examples, the caching tool 128 may detect an execution failure 134 of an action for the transaction 122. The failure of any action in the transaction 122 can cause the transaction 122 as a whole to fail. Therefore, in response to detecting the execution failure 134, the caching tool 128 may remove the second stateful information 118b or other suitable data associated with the transaction 122 from the cache 116. Similarly, the caching tool 128 may, in some examples, detect a caching failure 132 of the asynchronous caching function 114. An example of the caching failure 132 can be a failure to store the second stateful information 118b in the cache 116. In response to detecting the caching failure 132, the caching tool 128 may cause the software application 104 to abort the transaction 122.

Although FIG. 1 depicts a certain number and arrangement of components, this is for illustrative purposes and intended to be non-limiting. Other examples may include more components, fewer components, different components, or a different arrangement of the components shown in FIG. 1.

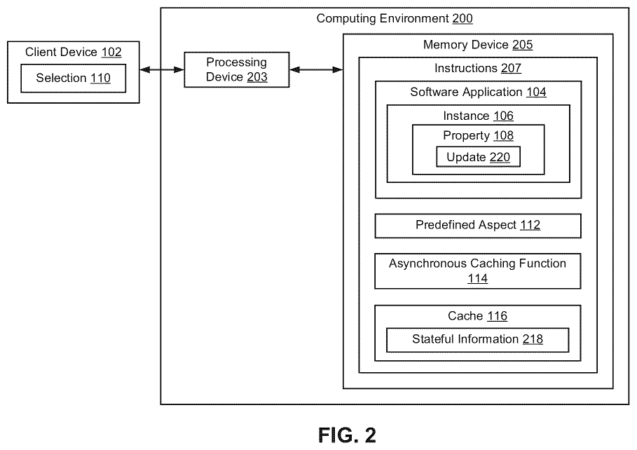

FIG. 2 is a block diagram of an example of a computing environment 200 for automatically executing an asynchronous caching function 114 to store stateful information according to one example of the present disclosure. The computing environment 200 includes a processing device 203 communicatively coupled to a memory device 205. In some examples, the components of the computing environment 200, such as the processing device 203 and the memory device 205, may be part of a same computing device. In other examples, the processing device 203 and the memory device 205 can be included in separate computing devices that are communicatively coupled.

The processing device 203 can include one processing device or multiple processing devices. Non-limiting examples of the processing device 203 can include a Field-Programmable Gate Array (FPGA), an application-specific integrated circuit (ASIC), and a microprocessor. The processing device 203 can execute instructions 207 stored in the memory device 205 to perform computing operations. In some examples, the instructions 207 can include processor-specific instructions generated by a compiler or an interpreter from code written in any suitable computer-programming language, such as C, C++, C#, etc.

The memory device 205 can include one memory or multiple memories. The memory device 205 can be non-volatile and may include any type of memory that retains stored information when powered off. Non-limiting examples of the memory device 205 include electrically erasable and programmable read-only memory (EEPROM), flash memory, or any other type of non-volatile memory. At least some of the memory device 205 can include a non-transitory computer-readable medium from which the processing device 203 can read instructions 207. A computer-readable medium can include electronic, optical, magnetic, or other storage devices capable of providing the processing device 203 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 207. In some examples, the instructions 207 may correspond to the caching tool 128 described in FIG. 1. The memory device 205 may also include a cache 116 that may store stateful information 218 for the software application 104. The stateful information 218 can correspond to the first stateful information 118a or the second stateful information 118b of FIG. 1.

In some examples, the processing device 203 can execute the instructions 207 to perform some or all of the functionality described herein. For example, the processing device 203 can detect, based on a selection 110 from a client device 102, an update 220 to a property 108 of an instance 106 of a software application 104. The processing device 203 can also identify a match between the update 220 to the property 108 and a predefined aspect 112. In response to identifying the match, the processing device 203 can determine stateful information 218 for the instance 106 based on the selection 110 from the client device 102. Moreover, in response to determining the stateful information 218, the processing device 203 can automatically execute an asynchronous caching function 114 to store, in a cache 116, the stateful information 218.

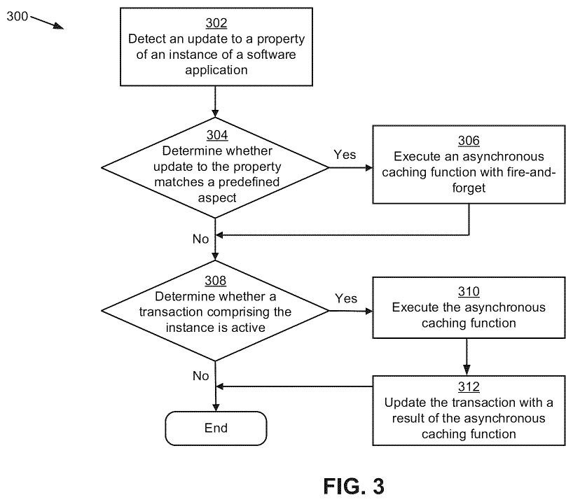

In some examples, the processing device 203 can implement some or all steps shown in FIGS. 3-5. Other examples can include more steps, fewer steps, different steps, or a different order of the steps than is shown in FIGS. 3-5. The steps of FIGS. 3-5 are discussed below with reference to the components discussed above in relation to FIGS. 1-2.

Referring now to FIG. 3, FIG. 3 is a flowchart of an example of a process 300 for automatically executing an asynchronous caching function 114 to store stateful information according to one example of the present disclosure. At block 302, the processing device 203 detects an update 220 to a property 108 of an instance 106 of a software application. The update 220 to the property 108 of the instance 106 can occur as a result of a user interacting with the software application 104. For example, the user can be interacting with the software application 104 to make a purchase. Additionally, the processing device 203 may detect the update 220 based on a selection 110 by a client device 102. For example, the selection 110 can be a selection from the client device 102 to purchase an item via the software application 104. The software application 104 can include a type for items. The instance 106 can be the item and properties of the instance 106 can include a price, a name of the item, and an indication of whether the item is available. The update 220 to the property 108 can indicate that the item is unavailable due to the selection 110.

At block 304, the processing device 203 determines whether the update 220 to the property 108 matches a predefined aspect 112. In a first example, the predefined aspect 112 can specify that an item being updated to have a property value of unavailable should be cached. In a second example, the predefined aspect 112 can specify that an update to a price of an item should not be cached. Thus, the in first example, the processing device 203 can determine that the update 220 to the property 108 matches the predefined aspect 112 and can proceed to block 306 of the process 300. Conversely, in the second example, the processing device 203 can determine that the update 220 to the property 108 does not match the predefined aspect 112 and can proceed directly to block 308 of the of the process 300.

At block 306, the processing device 203, in response to determining that the update 220 to the property 108 does match the predefined aspect 112, executes an asynchronous caching function 114 with fire-and-forget. In the first example, the processing device 203 may determine first stateful information 118a for the update 220 to the property 108. For example, the first stateful information 118a may include a timestamp of the update 220, the price, and the name of the item. The processing device 203 may then execute the asynchronous caching function 114 to store the first stateful information 118a in a cache 116.

Additionally, the processing device 203 may execute the asynchronous caching function 114 of block 306 with the fire-and-forget. Fire-and-forget is a communication approach in which a connection between the software application 104 and execution of the asynchronous caching function 114 can be terminated when execution of the asynchronous caching function 114 begins. This can enable the software application 104 to run separately from the execution of the asynchronous caching function 114. As a result, an issue with the asynchronous caching function 114, such as a failure to store the update 220 to the property 108, may not disrupt the execution of the software application 104.

At block 308, the processing device 203 determines whether a transaction 122 comprising the instance 106 is active. For the process 300, the steps of determining whether the update 220 to the property 108 matches the predefined aspect 112 and determining whether the transaction 122 comprising the instance 106 is active can occur as non-mutually exclusive operations. Therefore, the processing device 203 can determine whether the update 220 matches the predefined aspect 112 and whether the transaction 122 is active concurrently. Additionally, due to the steps being non-mutually exclusive, the processing device 203 can determine whether the transaction 122 is active regardless of whether the update 220 matches the predefined aspect. Thus, in the first example, the processing device 203 can execute the asynchronous caching function 114 of block 306 and determine whether the transaction 122 is active. Conversely, in the second example, the processing device 203 may not execute the asynchronous caching function 114 of block 306 and then may determine whether the transaction 122 is active.

For both the first and second examples, the transaction 122 can be a series of actions for updating a payment history for the client device as a result of the selection 110. Therefore, for both the first and second examples, it can be determined that the transaction 122 comprising the instance 106 is active.

At block 310, the processing device 203, in response to determining that the transaction 122 comprising the instance 106 is active, executes the asynchronous caching function 114. For example, the processing device 203 may also determine second stateful information 118b associated with the transaction 122. The second stateful information 118b can include the price of the item and the name of the item. The processing device 203 may then execute the asynchronous caching function 114 a second time to store the second stateful information 118b in the cache 116.

In some examples, the processing device 203 may not execute the asynchronous caching function 114 associated with the transaction 122 with the fire-and-forget. The transaction 122 can be a set of actions that are required to complete a task. Failure of an action of the set actions can cause the transaction 122 to fail. Therefore, in some examples it can be desirable to execute the asynchronous caching function 114 without fire-and-forget (i.e., without terminating the connection between the software application 104 and the asynchronous caching function 114). For example, the connection can enable the second stateful information 118b to be removed from the cache 116 if the transaction 122 fails.

At block 312, the processing device 203 updates the transaction 122 with a result of the asynchronous caching function 114. For example, the result of the asynchronous caching function 114 can be storage of the price and the name of the item purchased. Then, due to the transaction 122 being associated with updating the payment history for the client device 102, the second stateful information 118b (e.g., the price) can be used to update the payment history.

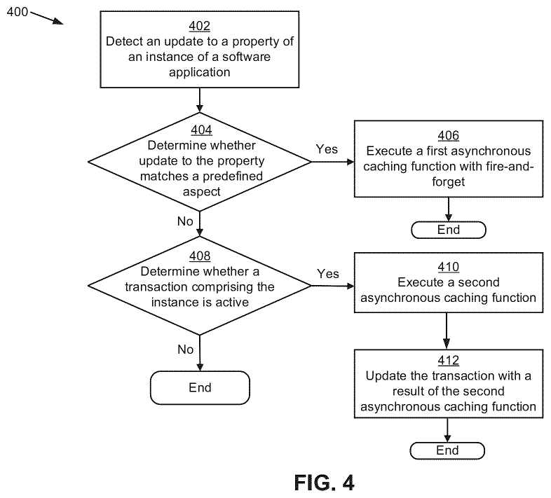

FIG. 4 is a flowchart of an example of a process 400 for automatically executing an asynchronous caching function 114 to store stateful information according to one example of the present disclosure. At block 402, the processing device 203 detects an update 220 to a property 108 of an instance 106 of a software application 104. The processing device 203 may detect the update 220 based on a selection 110 by a client device 102. For example, the selection 110 can be a selection from the client device 102 to purchase an item via software application 104. Therefore, the instance 106 can be the item and properties of the instance 106 can include a price of the item, a name of the item, and an indication of whether the item is available. The update 220 to the property 108 can indicate that the item is unavailable due to the selection 110.

At block 404, the processing device 203 determines whether the update 220 to the property 108 matches a predefined aspect 112. In a first example, the predefined aspect 112 can specify that an item being updated to have a property value of unavailable should be cached. In a second example, the predefined aspect 112 can specify that an update to a price of an item should not be cached. Thus, the in first example, the processing device 203 can determine that the update 220 to the property 108 matches the predefined aspect 112 and can proceed to block 406 of the process 400. Conversely, in the second example, the processing device 203 can determine that the update 220 to the property 108 does not match the predefined aspect 112 and can proceed directly to block 408 of the of the process 400.

At block 406, the processing device 203, in response to determining that the property 108 does match the predefined aspect 112, executes an asynchronous caching function 114 with fire-and-forget. In the first example, the processing device 203 may determine stateful information 218 for the update 220 to the property 108. For example, the stateful information 218 may include a timestamp of the update 220, the price of the item, and the name of the item. The processing device 203 may then execute the asynchronous caching function 114 to store the stateful information 218 in a cache 116.

At block 408, the processing device 203 determines whether a transaction 122 comprising the instance 106 is active. For the process 400, the steps of determining whether the update 220 to the property 108 matches the predefined aspect 112 and determining whether the transaction 122 comprising the instance 106 is active can be mutually exclusive operations. Therefore, the processing device 203 can determine whether the update 220 matches the predefined aspect 112. If it does, such as in the first example, the process 400 can end after the execution the asynchronous caching function 114 of block 406. Conversely, in the second example, the processing device 203 may not execute the asynchronous caching function 114 of block 406 and then may determine whether the transaction 122 is active. The transaction 122 can be a series of actions for updating a payment history for the client device as a result of the selection 110. Therefore, for the second example, it can be determined that the transaction 122 comprising the instance 106 is active.

At block 410, the processing device 203, in response to determining that the transaction 122 comprising the instance 106 is active, executes the asynchronous caching function 114. In the second example, the processing device 203 determines stateful information 218 for selection 110, such as the timestamp of the purchase, the price of the item, and the name of the item. The processing device 203 may then execute the asynchronous caching function 114 to store the stateful information 218 in the cache 116. In this way, the stateful information 218 for the selection 110 can be cached for updates not indicated by the predefined aspect 112. This can improve the automation of detecting and storing stateful information by caching parts of code that may not be directly indicated by a predefined aspect, such as original source code that may be inaccessible to the software developer.

At block 412, the processing device 203 updates the transaction 122 with a result of the asynchronous caching function 114. For example, the result of the asynchronous caching function 114 can include storage of the price and the name of the item that was purchased. Then, due to the transaction 122 being associated with updating the payment history for the client device 102, the second stateful information 118b can be used to update the payment history.

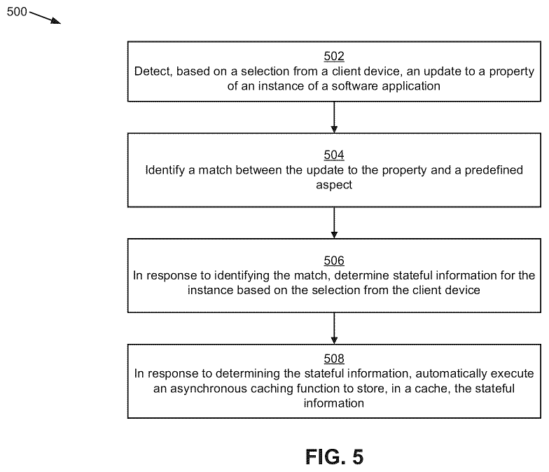

FIG. 5 is a flowchart of an example of a process 500 for automatically executing an asynchronous caching function 114 to store stateful information according to one example of the present disclosure. At block 502, the processing device 203 detects, based on a selection 110 from a client device 102, an update 220 to a property 108 of an instance 106 of a software application 104. In an example, the software application 104 can be for file sharing and collaboration. A type for the software application 104 can be documents, which can be shared, revised, etc. via the software application 104. Thus, the instance 106 of the software application 104 can be a specific document. Properties of the instance 106 can include a name of the specific document and contents of the specific document. Additionally, in the example, a user can be accessing the software application 104 via the client device 102 to revise the specific document. Then, the selection 110 from the client device 102 can involve a selection of a save option for the specific document, which the user may select via the client device 102 after revising the specific document. The processing device 203 can detect the selection 110 from the client device 102. Additionally, based on the selection 110, the processing device 203 can detect the update 220 the property 108 of the instance 106 as an update to the contents of the specific document.

At block 504, the processing device 203 identifies a match between the update 220 to the property 108 and a predefined aspect 112. For example, the predefined aspect 112 can indicate that at the selection 110 of the save option, if an update has been made to the name of a document or to the contents of a document, an asynchronous caching function 114 should be executed. Therefore, in the example, the processing device 203 can determine that the update 220 to the property 108 matches the predefined aspect 112.

At block 506, the processing device 203, in response to identifying the match, determines stateful information 218 for the instance 106 based on the selection 110 from the client device 102. The stateful information 218 can be data associated with the revisions to the specific document. The stateful information 218 can include enough data such that the specific document can be retrieved in a state corresponding to when the save option was selected. Thus, the stateful information 218 may include contents added to the specific document, contents removed from the specific document, etc.

At block 508, the processing device 203, in response to determining the stateful information 218, automatically executes the asynchronous caching function 114 to store, in a cache 116, the stateful information 218. In this way, the processing device 203 can automate the storage of stateful information 218, thereby enabling states of the software application 104 to be maintained efficiently. For example, the user can be a first user and the client device 102 can be a first client device. Subsequent to the first user revising the specific document via the first client device, a second user of a second client device may desire access to a revised version of the specific document. Due to the processing device 203 executing the asynchronous caching function 114 to store the stateful information 218 in the cache 116, the software application 104 can provide the revised version of the specific document at the second client device.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
detecting, based on a selection from a client device, an update to a property of an instance of a software application;
identifying a match between the update to the property and a predefined aspect;
in response to identifying the match, determining stateful information for the instance based on the selection from the client device; and
in response to determining the stateful information, automatically executing an asynchronous caching function to store, in a cache, the stateful information.

2. The system of claim 1, wherein the stateful information is first stateful information, and wherein the memory device further includes instructions executable by the processing device for causing the processing device to perform operations comprising:
subsequent to the selection from the client device, determining that a transaction comprising the instance is active for the software application; and
in response to determining that the transaction is active, automatically executing the asynchronous caching function to store, in the cache, second stateful information associated with execution of a first action of the transaction.

3. The system of claim 2, wherein the update is a first update and wherein the memory device further includes instructions executable by the processing device for causing the processing device to perform operations comprising:
detecting a second update associated with the instance of the software application, wherein the second update is generated during execution of the first action of the transaction;
determining that the second update matches the predefined aspect; and
in response to determining that the second update matches the predefined aspect, determine the second stateful information.

4. The system of claim 2, wherein the memory device further includes instructions executable by the processing device for causing the processing device to perform operations comprising:
executing a second action of the transaction based at least in part on the second stateful information stored in the cache.

5. The system of claim 2, wherein the memory device further includes instructions executable by the processing device for causing the processing device to perform operations comprising:
detecting a caching failure of the asynchronous caching function; and
in response to detecting the caching failure, aborting the transaction.

6. The system of claim 2, wherein the memory device further includes instructions executable by the processing device for causing the processing device to perform operations comprising:
detecting an execution failure of at least one action of the transaction; and
in response to detecting the execution failure, removing the second stateful information from the cache.

7. The system of claim 1, wherein the update is a first update and the stateful information is first stateful information, and wherein the memory device further includes instructions executable by the processing device for causing the processing device to perform operations comprising:
detecting a third update associated with the instance of the software application;
determining that the third update does not match the predefined aspect and determining that a transaction comprising the instance is active for the software application; and
in response to determining that third update does not match the predefined aspect and that the transaction is active, automatically executing the asynchronous caching function to store, in the cache, second stateful information associated with execution of a first action of the transaction.

8. The system of claim 1, wherein the predefined aspect comprises a set of entity classes, wherein each entity class of the set of entity classes is associated with one or more instances, and wherein the operation of determining that the update to the property matches the predefined aspect comprises:
determining that the instance is associated with an entity class of the set of entity classes.

9. A method comprising:
detecting, based on a selection from a client device and by a processing device, an update to a property of an instance of a software application;
identifying, by the processing device, a match between the update to the property and a predefined aspect;
in response to identifying the match, determining, by the processing device, stateful information for the instance based on the selection from the client device; and
in response to determining the stateful information, automatically executing, by the processing device, an asynchronous caching function to store, in a cache, the stateful information.

10. The method of claim 9, wherein the stateful information is first stateful information, and wherein method further comprises:
subsequent to the selection from the client device, determining that a transaction comprising the instance is active for the software application; and
in response to determining that the transaction is active, automatically executing the asynchronous caching function to store, in the cache, second stateful information associated with execution of a first action of the transaction.

11. The method of claim 10, wherein the update is a first update and wherein the method further comprises:
detecting a second update associated with the instance of the software application, wherein the second update is generated during execution of the first action of the transaction;
determining that the second update matches the predefined aspect; and
in response to determining that the second update matches the predefined aspect, determine the second stateful information.

12. The method of claim 10, further comprising:
executing a second action of the transaction based at least in part on the second stateful information stored in the cache.

13. The method of claim 10, further comprising:
detecting a caching failure of the asynchronous caching function; and
in response to detecting the caching failure, aborting the transaction.

14. The method of claim 10, further comprising:
detecting an execution failure of at least one action of the transaction; and
in response to detecting the execution failure, removing the second stateful information from the cache.

15. The method of claim 9, wherein the update is a first update and the stateful information is first stateful information, and wherein the method further comprises:
detecting a third update associated with the instance of the software application;
determining that the third update does not match the predefined aspect and determining that a transaction comprising the instance is active for the software application; and
in response to determining that third update does not match the predefined aspect and that the transaction is active, automatically executing the asynchronous caching function to store, in the cache, second stateful information associated with execution of a first action of the transaction.

16. A non-transitory computer-readable medium comprising instructions that are executable by a processing device for causing the processing device to perform operations comprising:
detecting, based on a selection from a client device, an update to a property of an instance of a software application;
identifying a match between the update to the property and a predefined aspect;
in response to identifying the match, determining stateful information for the instance based on the selection from the client device; and
in response to determining the stateful information, automatically executing an asynchronous caching function to store, in a cache, the stateful information.

17. The non-transitory computer-readable medium of claim 16, wherein the stateful information is first stateful information, and further comprising instructions that are executable by the processing device for causing the processing device to perform operations comprising:
subsequent to the selection from the client device, determining that a transaction comprising the instance is active for the software application; and
in response to determining that the transaction is active, automatically executing the asynchronous caching function to store, in the cache, second stateful information associated with execution of a first action of the transaction.

18. The non-transitory computer-readable medium of claim 17, wherein the update is a first update and further comprising instructions that are executable by the processing device for causing the processing device to perform operations comprising:
detecting a second update associated with the instance of the software application, wherein the second update is generated during execution of the first action of the transaction;
determining that the second update matches the predefined aspect; and
in response to determining that the second update matches the predefined aspect, determine the second stateful information.

19. The non-transitory computer-readable medium of claim 17, further comprising instructions that are executable by the processing device for causing the processing device to perform operations comprising:
executing a second action of the transaction based at least in part on the second stateful information stored in the cache.

20. The non-transitory computer-readable medium of claim 17, further comprising instructions that are executable by the processing device for causing the processing device to perform operations comprising:
detecting a caching failure of the asynchronous caching function; and
in response to detecting the caching failure, aborting the transaction.
